(19) United States
(12) Patent Application Publication
(10) Pub. No.: US 2021/0245540 A1
(43) Pub. Date: Aug. 12, 2021

(54) FABRIC PRINTABLE MEDIUM

(71) Applicant: Hewlett-Packard Development Company, L.P., Spring, TX (US)

(72) Inventors: Xulong Fu, San Diego, CA (US); Xiaoqi Zhou, San Diego, CA (US)

(21) Appl. No.: 17/271,131

(22) PCT Filed: Mar. 27, 2019
(86) PCT No.: PCT/US2019/024287

§ 371 Date: Feb. 24, 2021

(51) Int. Cl. B41M 5/50; B41M 5/52; D06P 5/30

(52) U.S. Cl. CPC B41M 5/508; B41M 5/504; B41M 5/5227; B41M 2205/38; B41M 5/5263; D06P 5/30; B41M 2205/36; B41M 5/5254

(57) ABSTRACT

A fabric printable medium that comprises a fabric base substrate with an image-side and a back-side. An ink-receiving layer comprising, at least, one crosslinked polymeric network, is applied to the image-side of the fabric base substrate; an opaque layer comprising polymeric binder and filler particles, is applied to the back-side of the fabric base substrate; a black light absorption layer comprising polymeric binders, filler particles and black pigment, is applied over the opaque layer; and a protective layer comprising two or more binders is applied on the top of black light absorption layer. Also described herein are a method for forming the fabric printable medium and a printing method that includes ejecting an ink composition onto the fabric print medium described herein.

### BACKGROUND

Inkjet printing technology has expanded its application to high-speed, commercial and industrial printing, in addition to home and office usage, because of its ability to produce economical, high quality, multi-colored prints. This technology is a non-impact printing method in which an electronic signal controls and directs droplets or a stream of ink that can be deposited on a wide variety of medium substrates. Inkjet printing technology has found various applications on different substrates including, for examples, cellulose paper, metal, plastic, fabric, and the like. The substrate plays a key role in the overall image quality and permanence of the printed images. One of the substrates is textile. Textile is a flexible material consisting of a network of natural or artificial fibers which form yarn or thread having an assortment of uses in the daily life. Textile printing has various applications including the creation of signs, banners, artwork, apparel, wall coverings, window coverings, upholstery, pillows, blankets, flags, tote bags, etc. It is a growing and evolving area and is becoming a trend in the visual communication market. As the area of textile printing continues to grow and evolve, the demand for new printable mediums increases.

### BRIEF DESCRIPTION OF THE DRAWINGS

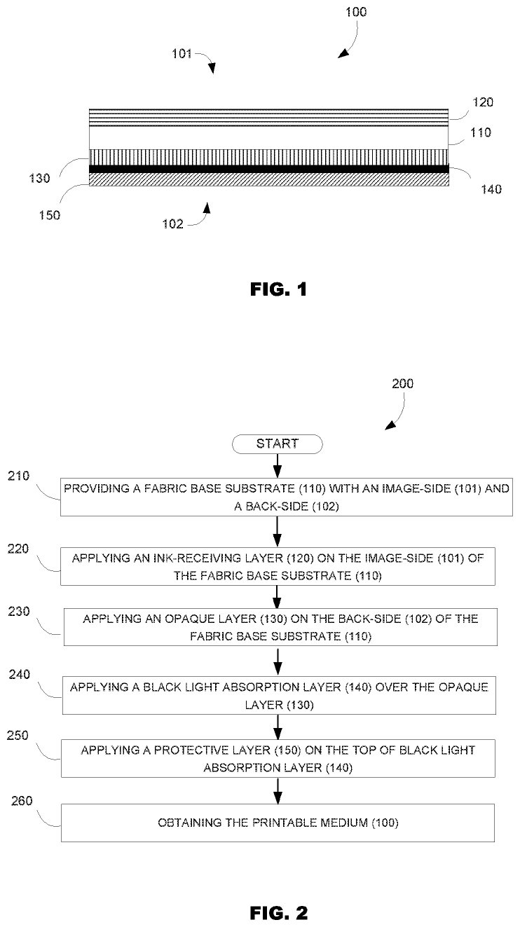

The drawings illustrate various examples of the present fabric printable medium and are part of the specification. FIG. 1 is a cross-sectional view of the fabric printable medium according to some examples of the present disclosure. FIG. 2 is a flowchart illustrating a method for producing the fabric printable medium according to one example of the present disclosure.

### DETAILED DESCRIPTION

When printing on fabric substrates, challenges exist due to the specific nature of fabric. Indeed, often, fabric does not accurately receive inks. Some fabrics, for instance, can be highly absorptive, diminishing color characteristics, while some synthetic fabrics can be crystalline, decreasing aqueous ink absorption leading to ink bleed. These characteristics result in the image quality on fabric being relatively low. Additionally, black optical density, color gamut, and sharpness of the printed images are often poor compared to images printed on cellulose paper or other media types. Durability, such as rubbing resistance, is another concern when printing on fabric, particularly when pigmented inks and ink compositions containing latex are used. To overcome these challenges, a functional coating, such as an image-receiving coating, is applied to the surface of the fabric substrate. However, since coating compositions contain some flammable substances such as polymeric binders, when such fabric printing media is intended to be used in close proximity to indoor environments (as drapes, as overhead signage, as part of furnishings, or the like), there are concerns about flame resistance as well as about using coatings that increase the flammability of the fabric. Thus, fire/flame resistance or inhibition characteristics of the coating compositions are also desirable when providing printable fabrics.

In one example, the present disclosure is drawn to fabric printable medium, with an image-side and a back-side, comprising a fabric base substrate; an ink-receiving layer comprising, at least, one crosslinked polymeric network, applied to the image-side of the fabric base substrate; an opaque layer comprising polymeric binder and filler particles, applied to the back-side of the fabric base substrate, a black light absorption layer comprising polymeric binders, filler particles and black pigment, applied over the opaque layer; and a protective layer comprising two or more binders applied on the top of black light absorption layer.

The present disclosure also relates to a method for forming said fabric printable medium and to the printing method using said fabric printable medium. The method for forming a fabric printable medium comprises providing a fabric base substrate, with an image-side and a back-side; applying an ink-receiving layer comprising, at least, one crosslinked polymeric network, on the image-side of the fabric base substrate; applying an opaque layer, comprising polymeric binder and filler particles, on the back-side of the fabric base substrate; applying a black light absorption layer, comprising polymeric binders, filler particles and black pigment, over the opaque layer; and applying a protective layer, comprising two or more binders, on the top of black light absorption layer.

The printable medium is an opaque medium which means that medium does not allow the light to diffuse and/or pass thought it. By opaque, it is meant herein that the fabric printable medium has an opacity that is of 99% or above. It can also mean that 99% of the lights, or more, will be absorbed in or reflected by the surface of the fabric printable medium (The opacity is tested using TAPPI test method T425 and is expressed in percentage %).

In some examples, the fabric printable medium is designed to be used in banner applications, in some other examples in “blockout banner” applications. The fabric printable medium can be a blockout banner which means that the media is very well adapted for banner application that would block the light transmission though the media at all points over the area of the banner. The fabric printable medium is an opaque printable medium; in some other examples, the fabric printable medium is an opaque banner. By “banner applications”, it is meant herein a media that has been designed, very often in a form of wide format, or large format, for being used in many public places both indoors and outdoors.

The fabric printable medium of the present disclosure has very good printing characteristics and durability performances. As good printing characteristics, it is meant herein good black optical density, good color gamut and sharpness of the printed image. The images printed on the fabric printable medium will thus be able to impart excellent image quality: vivid color, such as higher gamut and high color density. High print density and color gamut volume are realized with substantially no visual color-to-color bleed and with good coalescence characteristics. The images printed on the fabric printable medium will have excellent durability; specifically, it will have excellent durability under mechanical actions such as rubbing and scratching. The fabric printable medium, according to the present disclosure, is a printable recording medium (or printable media) that provide printed images that have outstanding print durability and excellent scratch resistance while maintaining good printing image quality (i.e. printing performance). In addition, the fabric printable medium has good flame resistance properties. By “scratch resistance”, it is meant herein that the composition is resistant to any modes of scratching which include, scuff and abrasion. By the term “scuff”, it is meant herein damages to a print due to dragging something blunt across it (like brushing fingertips along printed image). Scuffs do not usually remove colorant, but they do tend to change the gloss of the area that was scuffed. By the term “abrasion”, it is meant herein the damage to a print due to wearing, grinding or rubbing away due to friction. Abrasion is correlated with removal of colorant (i.e. with the OD loss).

In some examples, the fabric printable medium described herein is a coated printable media that can be printed at speeds needed for commercial and other printers such as, for example, HP Latex printers such as 360, 560, 1500, 3200 and 3600 (HP Inc., Palo Alto, Calif., USA). The image printed on the fabric printable medium of the present disclosure exhibits excellent printing qualities and durability. By using coating compositions, in combination with fabric substrate, the printing process is more accurate, and the printed image is more permanent. The resultant printed fabric will also be able to provide fire/flame resistance or inhibition to the fabric. The present disclosure refers to a fabric printable medium comprising a fabric base substrate and coating compositions applied to said fabric base substrate. The coating compositions, also called treatment compositions, once applied on the fabric base substrate, are solidified and form thin layers onto the fabric base surface.

FIG. 1 schematically illustrates some examples of the fabric printable medium (100) as described herein. FIG. 2 is a flowchart illustrating an example of a method for producing the fabric printable medium (200). As will be appreciated by those skilled in the art, FIG. 1 illustrates the relative positioning of the various layers of the printable media without necessarily illustrating the relative thicknesses of the various layers. It is to be understood that the thickness of the various layers is exaggerated for illustrative purposes.

As illustrated in FIG. 1, the fabric printable medium (100) encompasses a fabric base substrate, also called supporting base substrate or bottom substrate (110), and several coating layers: an ink-receiving layer (120), an opaque layer (130), a black light absorption layer (140) and a protective layer (150). The fabric printable medium (100) has two surfaces: a first surface which might be referred to as the “image receiving side”, “image surface” or “image side” (101) when coated with the image-receiving layer and a second surface, the opposite surface, which might be referred to as the “back surface” or “back-side” (102). The image receiving side is considered as the side where the image will be printed. The fabric base substrate (110) has also thus an image-side (101) and a back-side (102). In some examples, such as illustrated in FIG. 1, the fabric printable medium (100) encompasses a fabric base substrate (110) and an image-receiving coating layer (130) applied on the image-side (101) of the fabric base substrate (110). The opaque layer (130), the black light absorption layer (140) and the protective layer (150) are applied to the back-side” (102) of fabric base substrate (110). The opaque layer (130) is directly applied to the back-side (102) of the fabric base substrate (110). The black light absorption layer (140) is directly applied over the opaque layer (130) and the protective layer (150) is applied on the top of black light absorption layer (140).

An example of a method (200) for forming a fabric printable medium (100) in accordance with the principles described herein, by way of illustration and not limitation, is shown in FIG. 2. As illustrated in FIG. 2, such method encompasses providing (210) a fabric base substrate (110) with an image-side (101) and a back-side (102); applying (220) an ink-receiving layer (120) on the image-side (101) of the fabric base substrate (110); applying (230) an opaque layer (130) on the back-side (102) of the fabric base substrate (110); applying (240) a black light absorption layer (140) over the opaque layer (130); and applying (250) a protective layer (150) on the top of black light absorption layer (140) in order to obtain (260) the printable medium (100).

The printable medium (100) comprises a fabric base substrate (110) with an image-side and a back-side; an ink-receiving layer (120) with, at least, one crosslinked polymeric network, applied to the image-side of the fabric base substrate; an opaque layer (130) comprising polymeric binder and filler particles, applied to the back-side of the fabric base substrate, a black light absorption layer (140) comprising polymeric binders, filler particles and black pigment, applied over the opaque layer; and a protective layer (150) comprising two or more binders applied on the top of black light absorption layer. The printable medium (100) is a fabric printable medium (100). The printable medium can be an inkjet fabric printable medium. The printable medium can thus be specifically designed to receive any inkjet printable ink, such as, for example, organic solvent-based inkjet inks or aqueous-based inkjet inks. Examples of inkjet inks that may be deposited, established, or otherwise printed on the printable medium, include pigment-based inkjet inks, dye-based inkjet inks, pigmented latex-based inkjet inks, and UV curable inkjet inks.

The Fabric Base Substrate (110)

A fabric printable medium (100) of the present disclosure, that can also be called herein printable recording media, is a media that comprises a fabric base substrate (110). The fabric base substrate (110) can also be called bottom supporting substrate or fabric substrate. The word “supporting” also refers to a physical objective of the substrate that is to carry the coatings layer and the image that is going to be printed.

Regarding such fabric base substrate, any textile, fabric material, fabric clothing, or other fabric product where there is a desire for application of printed matter can benefit from the principles described herein. More specifically, fabric substrates useful in present disclosure include substrates that have fibers that may be natural and/or synthetic. The term “fabric” as used to mean a textile, a cloth, a fabric material, fabric clothing, or another fabric product. The term “fabric structure” is intended to mean a structure having warp and weft that is one of woven, non-woven, knitted, tufted, crocheted, knotted, and pressured, for example. The terms “warp” and “weft” refers to weaving terms that have their ordinary means in the textile arts, as used herein, e.g., warp refers to lengthwise or longitudinal yarns on a loom, while weft refers to crosswise or transverse yarns on a loom. It is notable that the term “fabric substrate” does not include materials commonly known as any kind of paper (even though paper can include multiple types of natural and synthetic fibers or mixture of both types of fibers). The paper thereon is defined as the felted sheet, roll and other physical forms that are made of various plant fibers (like trees or mixture of plant fibers) with synthetic fibers by laid down on a fine screen from a water suspension. Furthermore, fabric substrates include both textiles in its filament form, in the form of fabric material, or even in the form of fabric that has been crafted into finished article (clothing, blankets, tablecloths, napkins, bedding material, curtains, carpet, shoes, etc.). In some examples, the fabric base substrate has a woven, knitted, non-woven or tufted fabric structure.

In some examples, the fabric base substrate comprises wool, cotton, silk, linen, jute, flax, hemp, rayon, corn starch, tapioca, sugarcane, polyvinyl chloride, polyester, polyamide, polyimide, polyacrylic, polyacrylic polypropylene, polyethylene, polyurethane, polystyrene, polyaramid, polytetrafluoroethylene, polyethylene terephthalate, fiberglass, polytrimethylene, polycarbonate, polyester terephthalate, polybutylene terephthalate, or a combination thereof. In some other examples, the fabric base substrate is woven, knitted, non-woven or tufted and comprises natural or synthetic fibers selected from the group consisting of wool, cotton, silk, rayon, thermoplastic aliphatic polymers, polyesters, polyamides, polyimides, polypropylene, polyethylene, polystyrene, polytetrafluoroethylene, fiberglass, polycarbonates polytrimethylene terephthalate, polyethylene terephthalate and polybutylene terephthalate. In yet some other examples, the fabric base substrate is a synthetic polyester fiber.

In some examples, the fabric base substrate (110) has a basis weight that is ranging from about 50 gsm to about 400 gsm. In some other examples, the basis weight of the fabric substrate can range from about 100 gsm to about 300 gsm.

The fabric base substrate can be a woven fabric where warp yarns and weft yarns are mutually positioned at an angle of about 90°. This woven fabric includes, but is not limited to, fabric with a plain weave structure, fabric with twill weave structure where the twill weave produces diagonal lines on a face of the fabric, or a satin weave. The fabric base substrate can be a knitted fabric with a loop structure including one or both of warp-knit fabric and weft-knit fabric. The weft-knit fabric refers to loops of one row of fabric are formed from the same yarn. The warp-knit fabric refers to every loop in the fabric structure that is formed from a separate yarn mainly introduced in a longitudinal fabric direction. The fabric base substrate can also be a non-woven product, for example a flexible fabric that includes a plurality of fibers or filaments that are one or both of bonded together and interlocked together by a chemical treatment process (e.g., a solvent treatment), a mechanical treatment process (e.g., embossing), a thermal treatment process, or a combination of two or more of these processes.

The fabric base substrate can include one or both of natural fibers and synthetic fibers. Natural fibers that may be used include, but are not limited to, wool, cotton, silk, linen, jute, flax or hemp. Additional fibers that may be used include, but are not limited to, rayon fibers, or those of thermoplastic aliphatic polymeric fibers derived from renewable resources, including, but not limited to, cornstarch, tapioca products, or sugarcanes. These additional fibers can be referred to as “natural” fibers. In some examples, the fibers used in the fabric base substrate includes a combination of two or more from the above-listed natural fibers, a combination of any of the above-listed natural fibers with another natural fiber or with synthetic fiber, a mixture of two or more from the above-listed natural fibers, or a mixture of any thereof with another natural fiber or with synthetic fiber.

The synthetic fiber that may be used in the fabric base substrate can be a polymeric fiber including, but not limited to, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E. I. du Pont de Nemours Company), fiberglass, polytrimethylene, polycarbonate, polyethylene terephthalate or polybutylene terephthalate. In some examples, the fibers include a combination of two or more of the above-listed polymeric fibers, a combination of any of the above-listed polymeric fibers with another polymeric fiber or with natural fiber, a mixture of two or more of the above-listed polymeric fibers, or a mixture of any of the above-listed polymeric fibers with another polymer fiber or with natural fiber. In some examples, the synthetic fiber includes modified fibers from above-listed polymers. The term “modified fibers” refers to one or both of the polymeric fiber and the fabric as a whole having underwent a chemical or physical process such as, but not limited to, one or more of a copolymerization with monomers of other polymers, a chemical grafting reaction to contact a chemical functional group with one or both the polymeric fiber and a surface of the fabric, a plasma treatment, a solvent treatment, for example acid etching, and a biological treatment, for example an enzyme treatment or antimicrobial treatment to prevent biological degradation. The term “PVC-free” means no polyvinyl chloride (PVC) polymer or vinyl chloride monomer units in the substrate.

In some examples, the fabric base substrate contains both natural fiber and synthetic polymeric fiber. The amount of synthetic polymeric fibers can represent from about 20% to about 90% of the total amount of fiber. The amount of natural fibers can represent from about 10% to about 80% of amount of fiber.

The fabric base substrate may further contain additives including, but not limited to, one or more of colorant (e.g., pigments, dyes, tints), antistatic agents, brightening agents, nucleating agents, antioxidants, UV stabilizers, fillers and lubricants, for example. Alternatively, the fabric base substrate may be pre-treated in a solution containing the substances listed above before applying the coating composition. The additives and pre-treatments are included to improve various properties of the fabric.

The Ink-Receiving Layer (120)

The fabric printable medium (100) comprises a fabric base substrate (100) with an image-side (101) and a back-side (102) and an ink-receiving layer (120) comprising, at least, one crosslinked polymeric network, that is directly applied to the image-side of the fabric base substrate.

The ink-receiving layer comprises at least one crosslinked polymeric network. In some other examples, the ink-receiving layer comprises several crosslinked polymeric networks. The crosslinked polymeric networks can include a polyacrylate, polyurethane, vinyl-urethane, acrylic urethane, polyurethane-acrylic, polyether polyurethane, polyester polyurethane, polycaprolactam polyurethane, polyether polyurethane, alkyl epoxy resin, epoxy novolac resin, polyglycidyl resin, polyoxirane resin, polyamine, styrene maleic anhydride, derivative thereof, or combination thereof. In some examples, the crosslinked polymeric networks consist of different polymers.

In one example, the crosslinked polymeric network can include polyacrylate based polymers. Exemplary polyacrylate based polymers can include polymers made by hydrophobic addition monomers include, but are not limited to, C1-C12 alkyl acrylate and methacrylate (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl acrylate, methyl methacrylate, ethyl methacrylate, n-propyl methacrylate, isopropyl methacrylate, n-butyl methacrylate, isobutyl methacrylate, sec-butyl methacrylate, tert-butyl methacrylate), and aromatic monomers (e.g., styrene, phenyl methacrylate, o-tolyl methacrylate, m-tolyl methacrylate, p-tolyl methacrylate, benzyl methacrylate), hydroxyl containing monomers (e.g., hydroxyethyl acrylate, hydroxyethyl methacrylate), carboxylic containing monomers (e.g., acrylic acid, methacrylic acid), vinyl ester monomers (e.g., vinyl acetate, vinyl propionate, vinylbenzoate, vinylpivalate, vinyl-2-ethylhexanoate, vinyl-versatate), vinyl benzene monomer, C1-C12 alkyl acrylamide and methacrylamide (e.g., t-butyl acrylamide, sec-butyl acrylamide, N,N-dimethylacrylamide), crosslinking monomers (e.g., divinyl benzene, ethyleneglycoldimethacrylate, bis(acryloylamido)methylene), and combinations thereof. Polymers made from the polymerization and/or copolymerization of alkyl acrylate, alkyl methacrylate, vinyl esters, and styrene derivatives may also be useful. In one example, the polyacrylate based polymer can include polymers having a glass transition temperature greater than 20° C. In another example, the polyacrylate based polymer can include polymers having a glass transition temperature of greater than 40° C. In yet another example, the polyacrylate based polymer can include polymers having a glass transition temperature of greater than 50° C.

In one example, the crosslinked polymeric network can include a polyurethane polymer. The polyurethane polymer can be hydrophilic. The polyurethane can be formed in one example by reacting an isocyanate with a polyol. Exemplary isocyanates used to form the polyurethane polymer can include toluene-diisocyanate, 1,6-hexamethylenediisocyanate, diphenyl-methanediisocyanate, 1,3-bis(isocyanatemethyl)cyclohexane, 1,4-cyclohexyldiisocyanate, p-phenylenediisocyanate, 2,2,4(2,4,4)-trimethylhexamethylenediisocyanate, 4,4′-dicychlohexylmethanediisocyanate, 3,3′-dimethyldiphenyl, 4,4′-diisocyanate, m-xylenediisocyanate, tetramethylxylenediisocyanate, 1,5-naphthalenediisocyanate, dimethyl-triphenyl-methane-tetraisocyanate, triphenyl-methane-triisocyanate, tris(isocyanatephenyl)thiophosphate, and combinations thereof. Commercially available isocyanates can include Rhodocoat® WT 2102 (available from Rhodia AG, Germany), Basonat® LR 8878 (available from BASF Corporation, N. America), Desmodur® DA, and Bayhydur® 3100 (Desmodur and Bayhydur available from Bayer AG, Germany). In some examples, the isocyanate can be protected from water. Exemplary polyols can include 1,4-butanediol; 1,3-propanediol; 1,2-ethanediol; 1,2-propanediol; 1,6-hexanediol; 2-methyl-1,3-propanediol; 2,2-dimethyl-1,3-propanediol; neopentyl glycol; cyclo-hexane-dimethanol; 1,2,3-propanetriol; 2-ethyl-2-hydroxymethyl-1,3-propanediol; and combinations thereof. In some examples, the isocyanate and the polyol can have less than three functional end groups per molecule. In another example, the isocyanate and the polyol can have less than five functional end groups per molecule. In yet another example, the polyurethane can be formed from a polyisocyanate having at least two isocyanate functionalities and a polyol having at least two hydroxyl or amine groups. Exemplary polyisocyanates can include diisocyanate monomers and oligomers. In one example, the polyurethane prepolymer can be prepared with a NCO/OH ratio from about 1.2 to about 2.2. In another example, the polyurethane prepolymer can be prepared with a NCO/OH ratio from about 1.4 to about 2.0. In yet another example, the polyurethane prepolymer can be prepared using an NCO/OH ratio from about 1.6 to about 1.8.

In one example, the weight average molecular weight of the polyurethane prepolymer can range from about 20,000 Mw to about 200,000 Mw as measured by gel permeation chromatography. In another example, the weight average molecular weight of the polyurethane prepolymer can range from about 40,000 Mw to about 180,000 Mw as measured by gel permeation chromatography. In yet another example, the weight average molecular weight of the polyurethane prepolymer can range from about 60,000 Mw to about 140,000 Mw as measured by gel permeation chromatography. Exemplary polyurethane polymers can include polyester based polyurethanes, U910, U938 U2101 and U420; polyether-based polyurethane, U205, U410, U500 and U400N; polycarbonate-based polyurethanes, U930, U933, U915 and U911; castor oil-based polyurethane, CUR21, CUR69, CUR99 and CUR991; and combinations thereof. (All of these polyurethanes are available from Alberdingk Boley Inc., N.C.).

In some examples the polyurethane can be aliphatic or aromatic. In one example, the polyurethane can include an aromatic polyether polyurethane, an aliphatic polyether polyurethane, an aromatic polyester polyurethane, an aliphatic polyester polyurethane, an aromatic polycaprolactam polyurethane, an aliphatic polycaprolactam polyurethane, or a combination thereof. In another example, the polyurethane can include an aromatic polyether polyurethane, an aliphatic polyether polyurethane, an aromatic polyester polyurethane, an aliphatic polyester polyurethane, and a combination thereof. Exemplary commercially-available examples of these polyurethanes can include; NeoPac® R-9000, R-9699, and R-9030 (available from Zeneca Resins, Ohio), Printrite®DP376 and Sancure® AU4010 (available from Lubrizol Advanced Materials, Inc., Ohio), and Hybridur® 570 (available from Air Products and Chemicals Inc., Pennsylvania), Sancure® 2710, Avalure® UR445 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure® 878, Sancure® 815, Sancure® 1301, Sancure® 2715, Sancure® 2026, Sancure® 1818, Sancure® 853, Sancure® 830, Sancure® 825, Sancure® 776, Sancure® 850, Sancure® 12140, Sancure® 12619, Sancure® 835, Sancure® 843, Sancure® 898, Sancure® 899, Sancure® 1511, Sancure® 1514, Sancure® 1517, Sancure® 1591, Sancure® 2255, Sancure® 2260, Sancure® 2310, Sancure® 2725, Sancure® 12471, (all commercially available from available from Lubrizol Advanced Materials, Inc., Ohio), and combinations thereof.

In some examples, the polyurethane can be cross-linked using a cross-linking agent. In example, the cross-linking agent can be a blocked polyisocyanate. In another example, the blocked polyisocyanate can be blocked using polyalkylene oxide units. In some examples, the blocking units on the blocked polyisocyanate can be removed by heating the blocked polyisocyanate to a temperature at or above the deblocking temperature of the blocked polyisocyanate in order to yield free isocyanate groups. An exemplary blocked polyisocyanate can include Bayhydur® VP LS 2306 (available from Bayer AG, Germany). In another example, the crosslinking can occur at trimethyloxysilane groups along the polyurethane chain. Hydrolysis can cause the trimethyloxysilane groups to crosslink and form a silesquioxane structure. In another example, the crosslinking can occur at acrylic functional groups along the polyurethane chain. Nucleophilic addition to an acrylate group by an acetoacetoxy functional group can allow for crosslinking on polyurethanes including acrylic functional groups. In other examples the polyurethane polymer can be a self-crosslinked polyurethane. Self-crosslinked polyurethanes can be formed, in one example, by reacting an isocyanate with a polyol.

In another example, the crosslinked polymeric network can include an epoxy functional resin. In some other examples, the ink-receiving layer includes an epoxy functional resin. In yet some other examples, the ink-receiving layer includes an epoxy functional resin in an amount representing above 5% of the total amount of ingredients of the ink-receiving layer.

The epoxy resin can be an alkyl epoxy resin, an alkyl aromatic epoxy resin, an aromatic epoxy resin, epoxy novolac resins, epoxy resin derivatives, and combinations thereof. In some examples, the epoxy can include an epoxy functional resin having one, two, three, or more pendant epoxy moieties. Exemplary epoxy functional resins can include Ancarez® AR555 (commercially available from Air Products and Chemicals Inc., Pennsylvania), Ancarez® AR550, Epi-rez®3510W60, Epi-rez®3515W6, Epi-rez®3522W60 (all commercially available from Hexion, Tex.) and combinations thereof. In some examples, the epoxy resin can be an aqueous dispersion of an epoxy resin. Exemplary commercially available aqueous dispersions of epoxy resins can include Araldite® PZ3901, Araldite® PZ3921, Araldite® PZ3961-1, Araldite® PZ323 (commercially available from Huntsman International LLC, Texas), Waterpoxy® 1422 (commercially available from BASF, Germany), Ancarez® AR555 (commercially available from Air Products and Chemicals, Inc., Pennsylvania), and combinations thereof. In yet another example, the epoxy resin can include a polyglycidyl or polyoxirane resin.

In one example, the epoxy resin can be self-crosslinked. Self-crosslinked epoxy resins can include polyglycidyl resins, polyoxirane resins, and combinations thereof. Polyglycidyl and polyoxirane resins can be self-crosslinked by a catalytic homopolymerization reaction of the oxirane functional group or by reacting with co-reactants such as polyfunctional amines, acids, acid anhydrides, phenols, alcohols, and/or thiols.

In other examples, the epoxy resin can be crosslinked by an epoxy resin hardener. Epoxy resin hardeners can be included in solid form, in a water emulsion, and/or in a solvent emulsion. The epoxy resins hardener, in one example, can include liquid aliphatic amine hardeners, cycloaliphatic amine hardeners, amine adducts, amine adducts with alcohols, amine adducts with phenols, amine adducts with alcohols and phenols, amine adducts with emulsifiers, ammine adducts with alcohols and emulsifiers, polyamines, polyfunctional polyamines, acids, acid anhydrides, phenols, alcohols, thiols, and combinations thereof. Exemplary commercially available epoxy resin hardeners can include Anquawhite®100 (commercially available from Air Products and Chemicals Inc., Pennsylvania), Aradur® 3985 (commercially available from Huntsman International LLC, Texas), Epikure® 8290-Y-60 (commercially available from Hexion, Texas), and combinations thereof.

In one example, the crosslinked polymeric network can include an epoxy resin and the epoxy resin can include a water-based epoxy resin and a water-based polyamine. In another example, the crosslinked polymeric network can include a vinyl urethane hybrid polymer, a water-based epoxy resin, and a water-based polyamine epoxy resin hardener. In yet another example, the crosslinked polymeric network can include an acrylic-urethane hybrid polymer, a water-based epoxy resin, and a water-based polyamine epoxy resin hardener.

In a further example, the first or second crosslinked polymeric network can include a styrene maleic anhydride (SMA). In one example, the SMA can include NovaCote 2000® (Georgia-Pacific Chemicals LLC, Georgia). In another example, the styrene maleic anhydride can be combined with an amine terminated polyethylene oxide (PEO), amine terminated polypropylene oxide (PPO), copolymer thereof, or a combination thereof. In one example, combining a styrene maleic anhydride with an amine terminated PEO and/or PPO can strengthen the polymeric network by crosslinking the acid carboxylate functionalities of the SMA to the amine moieties on the amine terminated PEO and/or PPO. The amine terminated PEO and/or PPO, in one example, can include amine moieties at one or both ends of the PEO and/or PPO chain, and/or as branched side chains on the PEO and/or PPO. In one example, utilizing an amine terminated PEO and/or PPO in combination with a SMA can allow for the user to retain the glossy features of the SMA while eliminating the brittle nature of SMA. Exemplary commercially available amine terminated PEO and/or PPO compounds can include Jeffamine® XTJ-500, Jeffamine® XTJ-502, and Jeffamine® XTJ D-2000 (all available from Huntsman International LLC, Texas). In some examples, a weight ratio of SMA to the amine terminated PEO and/or PPO can range from about 100:1 to about 2.5:1. In another, a weight ratio of the SMA to the amine terminated PEO and/or PPO can range from about 90:1 to about 10:1. In yet another example, a weight ratio of the SMA to the amine terminated PEO and/or PPO can range from about 75:1 to about 25:1.

In some examples, the first crosslinked polymeric network can be crosslinked to itself. In another example, the first crosslinked polymeric network can be crosslinked to itself and to the second crosslinked polymeric network. In one example, the second crosslinked polymeric network can be crosslinked to itself. When the first crosslinked polymeric network and the second crosslinked polymeric network are not crosslinked to one another they can be entangled or appear layered onto one another.

The ink-receiving layer may also include other coating additives such as surfactants, rheology modifiers, defoamers, optical brighteners, biocides, pH controlling agents, dyes, and other additives for further enhancing the properties of the coating. The total amount of optional coating additives may be in the range of 0 to 10 wt % based on the total amount of ingredients. Among these additives, rheology modifier or rheology control agent is useful for addressing runnability issues. Suitable rheology control agents include polycarboxylate-based compounds, polycarboxylated-based alkaline swellable emulsions, or their derivatives. The rheology control agent is helpful for building up the viscosity at certain pH, either at low shear or under high shear, or both. In certain embodiments, a rheology control agent is added to maintain a relatively low viscosity under low shear, and to help build up the viscosity under high shear. It is desirable to provide a coating formulation that is not so viscous during the mixing, pumping and storage stages, but possesses an appropriate viscosity under high shear.

In some examples, the ink-receiving layer further includes a rheology control agent. The rheology control agent can be high molecular weight polymers, i.e. having a molecular weight ranging from about 300,000 to about 1,000,000. The rheology control agent can be copolymers of acrylates, copolymers with acrylate-based polyelectrolyte backbone, copolymers with polyester backbone, or copolymers with polyurethane based copolymer backbone. The rheology control agent can also be a copolymer with polyester backbone. In some examples, the rheology control agent is selected from the group consisting of copolymers of acrylates, copolymers with acrylate-based polyelectrolyte backbone, copolymers with polyester backbone, and copolymers with polyurethane based copolymer backbone.

Examples of such rheology control agent include Acusol®810A, Acusol L®830, Acusol®835, Acusol® 842 (supplied by Rohm Haas/Dow Co); or Alcogum® L11, Alcogum® L12, Alcogum® L51, Alcogum® L31 and Alcogum® L52 (available from Akzo Nobel Co). Still another example of a suitable physical networking agent is hydroxyethyl cellulose. An example that is commercially available is Tylose® HS30000 (from SE Tylose GmbH & Co. KG). Other examples of rheology modifiers or rheology control agent that meet this requirement include, but are not limited to, Sterocoll® FS (from BASF), Cartocoat® RM 12 (from Clariant), Acrysol® TT-615 (from Rohm and Haas) and Acumer® 9300 (from Rohm and Haas). The amount of rheology modifier in the coating composition may be in the range of about 0.5 to about 15 wt % parts, more preferably, in the range of about 1 to about 5 wt % parts, based on total weight of the ingredients.

In some examples, the ink-receiving layer (120) is disposed on the image-side (101) of the fabric base substrate (110), at a coat-weight in the range of about 0.1 to about 40 gram per square meter (g/m2 or gsm), or in the range of about 1 gsm to about 20 gsm, or in the range of about 3 to about 15 gsm.

Once applied to the image-side (101) of the film substrate (110), the ink-receiving layer (120) can be calendered. The calendering can be done either in room temperature or at an elevated temperature and/or pressure. In one example, the elevated temperature can range from 40° C. to 100° C. In one example, the calender pressure can range from about 100 psi to about 3,000 psi.

The Opaque Layer (130)

The fabric print medium (100) of the present disclosure includes a fabric base substrate 110, with an image-side (101) and a back-side (102). An ink-receiving layer (120) is applied to the image-side (101) of the fabric base substrate (110) and an opaque layer (130) is applied to the back-side (102) of the fabric base substrate (110). The opaque layer (130) can be considered as light reflective opaque layer with high reflective index pigments. The opaque layer (130) comprises polymeric binders and filler particles.

The opaque layer (130) can be applied on the back-side of the fabric base substrate at a dry coat-weight ranging from about 10 grams per square meter (g/m² or gsm) to about 80 grams per square meter (g/m² or gsm). In some examples, the opaque layer can be applied to the fabric base substrate a dry coat-weight ranging from about 15 gsm to about 70 gsm. In some other examples, the opaque layer can be applied to the fabric base substrate at a coating weight ranging from about 20 gsm to about 60 gsm.

The opaque layer or opaque reflective coating composition includes polymeric binders and filler. In some examples, the opaque reflective layer or opaque reflective coating composition includes a polymeric binder and filler particles with flame retardancy properties, also called flame-retardant agent. In some other examples, the opaque layer includes a polymeric binder and a flame-retardant dispersion.

In some examples, the opaque layer comprises the inorganic particle fillers which as reflective index greater than 2.0. In one example, the inorganic particle filler are titanium dioxide (TiO₂) particles (Reflection index=2.6). Titanium dioxide crystal size can be ranged around 350 to 180 nm in one example, and around 200 to 250 nm (measured by electron microscope) to optimize the maximum reflection of visible light. The titanium dioxide (TiO₂) particles can be present in an amount ranging from about 0.2 wt % to 3.5 wt % by total weight of the base film substrate. In some other examples, the opaque Reflective layer comprises inorganic particles that are titanium dioxide (TiO₂) particles and that are present in an amount ranging from about 0.3 wt % to 1.6 wt % by total weight of the base film substrate. The higher the TiO₂ amount, the higher of the opacity level will be.

The opaque layer (130), also called herein opaque reflective layer, may be described herein at least in terms of its opacity. As used herein, the opacity of a layer refers to the impenetrability of the layer to visible light. As such, an opaque substrate is one that is neither transparent nor translucent. In an example, the opaque layer will reflect, scatter, or absorb all of the electromagnetic waves in the spectrum range at which a human eye will respond, which is known as visible light; i.e., wavelengths ranging from about 390 nm to about 750 nm. In another example, the opaque layer has zero or close to zero light transmission within the visible light spectrum. In yet another example, the opacity of the substrate may be described by Equation (1):

I(x)=I₀e^{-κ}^{ᵥ}^{ρx} (Eqn 1)

where x is the distance that light travels through the substrate (i.e., the thickness of the substrate measured in meters), I(x) is the intensity of light (measured in W/m²) remaining at the distance x, I0 is the initial intensity of light (measured in W/m²) when x is zero (i.e., when the distance x is equal to 0), v is the light frequency (measured in Hz), ρ is the mass density of the substrate (measured in kg/m3), and κV is the opacity of the substrate. In an example, opaque layer (130) is a layer where the opacity κV is greater than a value that, when used in Equation 1, renders I(x)/I0 equal to or less than 0.05. In some examples, this value ranges from zero to 0.05, or ranges from about 0.01 to about 0.02.

The opaque layer composition contains polymeric binders. Without being linked by any theory, it is believed that the polymeric binder can provide binding function to the fillers to form a continuous layer and adhesion function between coating layers and the fabric substrate. The polymeric binder can be present, in the opaque layer composition, in an amount ranging from about 5 wt % to about 70 wt % by total weigh of the opaque layer composition.

The polymeric binder can be either a water-soluble, a synthetic or a natural substance or an aqueous dispersible substance like polymeric latex. In some other examples, the polymeric binder is polymeric latex. The polymeric binder can be a water-soluble polymer or water dispersible polymeric latex. In some examples, the polymeric binder has a glass transition temperature (Tg) that is less than 5° C. Indeed, it is believed that polymeric binder with higher glass transition temperature (Tg) might contribute to a stiff coating and can damage the fabric “hand feeling” of the printing media. In some examples, the polymeric binders have a glass transition temperature (Tg) ranging from −40° C. to 0° C. In some other examples, the polymeric binders have a glass transition temperature (Tg) ranging from −20° C. to −5° C. The way of measuring the glass transition temperature (Tg) parameter is described in, for example, Polymer Handbook, 3rd Edition, authored by J. Brandrup, edited by E. H. Immergut, Wiley-Interscience, 1989.

In some examples, the polymeric binders are crossed-linked binder. “Crossed-linked binder” refers to the fact that multiple polymer substances with reactive function groups can react with each other to form a between-molecular chain structure, a cross linker, a macro-molecular substance or a low molecular weight chemical with more than two function groups that can be used. Binders with “self-crosslink” capability can mean that macro-molecular chains have different reactive function groups that can be used. The cross-linked binders can balance both softness and mechanical strength of the coating layers.

Suitable polymeric binders include, but are not limited to, water-soluble polymers such as polyvinyl alcohol, starch derivatives, gelatin, cellulose derivatives, acrylamide polymers, and water dispersible polymers such as acrylic polymers or copolymers, vinyl acetate latex, polyesters, vinylidene chloride latex, styrene-butadiene or acrylonitrile-butadiene copolymers. Non-limitative examples of suitable binders include styrene butadiene copolymer, polyacrylates, polyvinylacetates, polyacrylic acids, polyesters, polyvinyl alcohol, polystyrene, polymethacrylates, polyacrylic esters, polymethacrylic esters, polyurethanes, copolymers thereof, and combinations thereof. In some examples, the binder is a polymer, or a copolymer selected from the group consisting of acrylic polymers or copolymers, vinyl acetate polymers or copolymers, polyester polymers or copolymers, vinylidene chloride polymers or copolymers, butadiene polymers or copolymers, styrene-butadiene polymers or copolymers and acrylonitrile-butadiene polymers or copolymers. In a further example, the polymeric binder can include an acrylonitrile-butadiene latex.

In some other examples, the binder component is a latex containing particles of a vinyl acetate-based polymer, an acrylic polymer, a styrene polymer, a styrene-butadiene rubber (SBR)-based polymer, a polyester-based polymer, a vinyl chloride-based polymer, or the like. In yet some other examples, the binder is a polymer, or a copolymer selected from the group consisting of acrylic polymers, vinyl-acrylic copolymers and acrylic-polyurethane copolymers. Such binders can be polyvinylalcohol or copolymer of vinylpyrrolidone. The copolymer of vinylpyrrolidone can include various other copolymerized monomers, such as methyl acrylates, methyl methacrylate, ethyl acrylate, hydroxyethyl acrylate, hydroxyethyl methacrylate, ethylene, vinylacetates, vinylimidazole, vinylpyridine, vinylcaprolactams, methyl vinylether, maleic anhydride, vinylamides, vinylchloride, vinylidene chloride, dimethylaminoethyl methacrylate, acrylamide, methacrylamide, acrylonitrile, styrene, acrylic acid, sodium vinylsulfonate, vinylpropionate, and methyl vinylketone, etc. Examples of binders include, but are not limited to, polyvinyl alcohols and water-soluble copolymers thereof, e.g., copolymers of polyvinyl alcohol and poly(ethylene oxide) or copolymers of polyvinyl alcohol and polyvinylamine; cationic polyvinyl alcohols; aceto-acetylated polyvinyl alcohols; polyvinyl acetates; polyvinyl pyrrolidones including copolymers of polyvinyl pyrrolidone and polyvinyl acetate; gelatin; silyl-modified polyvinyl alcohol; styrene-butadiene copolymer; acrylic polymer latexes; ethylene-vinyl acetate copolymers; polyurethane resin; polyester resin; and combination thereof. In some examples, the binder is carboxylated styrene-butadiene copolymer binder. Such binder can be commercially found under the tradename Genflow® and Acrygen® from Omnova Solutions.

The polymeric binder can include a polystyrene-butadiene emulsion, acrylonitrile butadiene latex, starch, gelatin, casein, soy protein polymer, carboxy-methyl cellulose, hydroxyethyl cellulose, acrylic emulsion, vinyl acetate emulsion, vinylidene chloride emulsion, polyester emulsion, polyvinyl pyrroilidene, polyvinyl alcohol, styrene butadiene emulsions, or a combination thereof. In one example, the polymeric binder can include starch and the starch can be an oxidized starch, cationized starch, esterified starch, enzymatically denatured starch, and combinations thereof. In another example, the polymeric binder can be a soybean protein. In yet another example, the polymeric binder can include polyvinyl alcohol. Exemplary PVA's can include Kuraray poval® 235, Mowiol® 6-98, Mowiol® 40-88, and Mowiol® 20-98 (all available from Kuraray America Inc., Houston Tex.). In a further example, the polymeric binder can include an acrylonitrile-butadiene latex.

The average molecular weight (Mw) of the polymeric binder can vary. In one example, the polymeric binder may have an average molecular weight (Mw) of about 5,000 to about 200,000. In another example, the average molecular weight of the polymeric binder can vary from 10,000 Mw to about 200,000 Mw. In yet another example, the average molecular weight of the polymeric binder can vary from 20,000 Mw to 100,000 Mw. In a further example, the average molecular weight of the polymeric binder can vary from 100,000 Mw to 200,000 Mw. In one example, the polymeric binder can have a weight average molecular weight from 5,000 Mw to 200,000 Mw and can include polystyrene-butadiene emulsion, acrylonitrile butadiene latex, starch, gelatin, casein, soy protein polymer, carboxy-methyl cellulose, hydroxyethyl cellulose, acrylic emulsion, vinyl acetate emulsion, vinylidene chloride emulsion, polyester emulsion, polyvinyl pyrroilidene, polyvinyl alcohol, styrene butadiene emulsions, or combination thereof.

Examples of polymeric binder include commercial chemicals marketed under the trade name Joncryl® (from BASF), Acronal® (from BASF), FlexBond® (from Rosco) and Sancure® (from Lubrizol). Examples of polymeric substance include also, but are not limited to, cellulose derivatives from the Pearl® serials (by Weyerhaeuser Inc.); cationic starch marketed as Chargemaster® (by Grain Processing Corporation); styrene-butadiene emulsions as marketed as Buna®SE serials (by Lanxess Inc.). In some examples, the polymeric binder can be, but is not limited to, Gencryl®9525 styrene/butadiene/acrylonitrile copolymer (from RohmNova, Akron Ohio), Gencryl®9750 styrene/butadiene/acrylonitrile (from RohmNova), STR 5401 styrene/butadiene (from Dow Chemical Company, Midland Mich.), Mowiol®4-98 polyvinyl alcohol (Kuraray America, Inc., Houston Tex.), Acronal®S728 aqueous dispersion of a styrene/n-butyl acetate polymer (available from BASF), GenFlo® specialty latex products (from Omnova), for example, or a combination of two or more of the above.

The polymeric binder can be present in the opaque layer in an amount representing from about 15 wt % to about 80 wt % of the total weight of the opaque layer. In one example, the polymeric binder can be present in an amount representing from about 15 wt % to about 70 wt % of the opaque layer. In another example, the polymeric binder can be present in an amount representing from about 20 wt % to about 60 wt % of the opaque layer. In yet another example, the polymeric binder can range from about 25 wt % to about 45 wt % of the opaque layer.

The opaque layer (130) contains a polymeric binder and filler particles. In some examples, the opaque layer (130) contains a polymeric binder and filler particle that have a nature of flame retardancy (or flame retardancy properties) or contains fillers and, separately, a flame-retardant agent. The fillers that have a nature of flame retardancy or flame retardancy properties can be considered as flame-retardant agents. In some examples, the opaque layer (130) contains a flame-retardant substance.

As “flame-retardant”, or “fire-retardant”, it is meant herein any substance (i.e. agent) that inhibits or reduces flammability or delays their combustion of the substance (i.e. herein the media) containing it. In other word, the flame-retardant agent will have flame or fire retardancy properties.

The filler can include inorganic powder, inorganic mineral powder, organic powder and mixture of the both. In one example, the filler particles can include titanium dioxide, calcium carbonate, kaolin, talc, calcium sulfate, barium sulfate, zinc oxide, zinc sulfide, zinc carbonate, satin white, aluminum silicate, diatomite, calcium silicate, magnesium silicate, silica, amorphous silica, synthetic amorphous silica, colloidal silica, alumina, colloidal alumina, boehmite, pseudo-boehmite, aluminum hydroxide, aluminum, lithopone, zeolite, magnesium carbonate, magnesium hydroxide, magnesium, calcium, clay, calcium carbonate, polystyrene, polymethacrylates, polyacrylates, polyolefins, polyethylene, polypropylene, copolymers, and combinations thereof. In one example, the filler particles can include calcium carbonate. The calcium carbonate can be in the form of ground calcium carbonate, precipitated calcium carbonate, modified forms thereof, and combinations thereof. In another example, the filler particles can include titanium dioxide and clay.

It is preferable that the fillers having a nature of flame retardance. In the current invention, the “fillers” can be the solid particles in the room temperature having a nature of flame retardance. In some examples, the “fillers” also refers to the solid powder package which include a solid powder in the room temperature which has lower or limited flame retardant in one example or has no capability of flame retardant in another example. In this case, the “filler package” or also called “filler” for short, comprises a solid particle compounds and a fire retardant either in solid or liquid state in room temperature. The examples of fillers are, for example, but not limited to, an organohalogenated compound, a polymeric brominated compound, a metal oxide and phosphorus containing composition, a phosphorus and halogen containing composition, a phosphorus containing composition, a nitrogen containing composition, a halogen, an organophosphate, or a combination thereof.

In one example, the fillers with flame retardant can include a mineral compound. Exemplary mineral compounds can include aluminum hydroxide, magnesium hydroxide, huntite (magnesium calcium carbonate), hydromangesite (hydrated magnesium carbonate), phosphorus, red phosphorus, boehmite (aluminum oxide hydroxide), boron compounds, or combinations thereof. In another example, the flame retardant in filler package can include either a liquid or a solid flame retardant such as organohalogenated compound. Exemplary organohalogenated compounds can include, organobromines, organochlorines, decabromodiphenyl ether, decabromodiphenyl ethane, and combinations thereof. In another example, the either the filler or flame retardant can include a polymeric brominated compound. Exemplary polymeric brominated compounds can include brominated polystyrenes, brominated carbonate oligomers, brominated epoxy oligomers, tetra-bromophthalic anhydride, tetra-bromobisphenol A, hexabromocyclododecane, chlorendic acid, ethers of chlorendic acid, chlorinated paraffins, and combinations thereof.

In yet another example, either the filler or flame retardant can include a metal and phosphorus containing composition. Example metal and phosphorus containing compositions can include aluminum diethylphosphinate, calcium diethylphosphinate, and combinations thereof. In a further example, either the filler or flame retardant can include a phosphorus and a halogen containing composition. Exemplary phosphorus and halogen containing compositions can include tris(2,3-dibromopropyl) phosphate, chlorinated organophosphates, tris(1,3-dichloro-2-propyl) phosphate, tetrekis(2-chloroethyl) dicloro-isopentyldiphosphate, tris (1,3-dichloroisopropyl) phosphate, tris(2-chloroisopropyl) phosphate, and combinations thereof. In example, either the filler or flame retardant can include a phosphorus containing composition. Exemplary phosphorus containing compositions can include phosphates, phosphonates, phoshpinates, and combinations thereof. In some examples, the phosphorus containing composition can have different oxidations states. In one example, the phosphorus containing composition can be a closed ring structure such as FR102® (available from Shanghai Xusen Non-Halogen Smoke Suppressing Fire Retardants Co. Ltd, China) and Aflammit® (available from Thor, Germany). In another example, the phosphorus containing composition can be a water-soluble phosphorus containing compound. Exemplary water-soluble phosphorus containing compositions can include, a phosphonate ester with one or two, closed 4 to 6-member phosphorus containing ring structures. In one example, the water-soluble phosphorus containing composition can be 5-ethyl-2-methyl-1,3,2,-dioxaphosphoranian-5-yl)methyl dimethyl phosphonate P oxide . In another example, the water-soluble phosphorus containing composition can be bis[(-ethyl-2-methyl-1,3,2-dioxaphosphorinan-5-yl)methyl] methyl phosphonate P,P′-dioxide. In another example, either the filler or flame retardant can include a nitrogen containing composition. Exemplary nitrogen containing compositions can include melamines, melamine derivatives, melamine, melamine cyanurate, melamine polyphosphate, melem (heptazine derivative), melon (heptazine derivative), and combinations.

In some examples, either the filler or flame retardant can be a combination of a phosphorus containing compound, a nitrogen containing compound, and/or a halogen. In one example, the flame retardant can include a phosphorus and a nitrogen containing composition. Exemplary phosphorus and nitrogen containing compositions can include ammonium polyphosphate (APP), poly 4,4-diaminodiphenyl methane spirocyclic pentaerythritol bisphosphonate (PDSPB), 1,4-di(diethoxy thiophosphamide bezene (DTPAB), and combinations.

In another example, either the filler or flame retardant can include an organophosphate. The organophosphate can include: aliphatic phosphate; aliphatic phosphonate; aromatic phosphonate; aliphatic organophosphate; aromatic organophosphate; polymeric organophosphate with 2 or 3 oxygen atoms attached to the central phosphorus and combinations.

Example of flame-retardant agents can be brominated aromatic type of compound such as, for examples, 1,2-Bis(pentabromophenyl) ethane (CAS #84852-53-9); 3,3′,5,5′-Tetrabromobisphenol A (CAS #79-94-7); Ethylene-bis-tetrabromo-phthalimide (CAS #32588-76-4); or polybrominated diphenyl ethers such as Decabromodiphenyl ether (CAS #1163-19-5). Commercially available bromine-based flame-retardant agents include products with the tradenames: Greencrest® (available from Albemate), Saytex® 621, Saytex® 8010, Saytex® 8010zd, Saytex® Bt-93w, Saytex® Bt-93, Saytex® Cp-2000, Saytex® Hp-3010, Saytex® Hp-7010g, Saytex® Hp-7010p, Saytex® Rb-49, Saytex® Rb-7001, Saytex® Rb-79, Saytex® Rb-7980, Saytex® Rb-9170, Saytex® PURshield (all available from Albemate); Firemaster® 2100R, Firemaster® 550, Firemaster® 504, Firemaster® 508, Firemaster® 800, Firemaster® 520, Firemaster® 602, Firemaster® 600, Firemaster® 552, Firemaster® CP-44HF, Firemaster® PBS-64HW, Firemaster® BZ-54HP (all available from Chemtura Group).

In some examples, the filler or flame retardant is present, in the opaque layer, in an amount representing from about 5 to about 85 wt % by total weigh of the opaque layer. In some other examples, the filler or flame retardant is present, in the opaque layer composition, in an amount representing from about 10 wt % to about 70 wt %, by total dry weight of the opaque layer composition. In yet some other examples, the filler or flame retardant is present, in the opaque barrier composition, in an amount representing from about 15 wt % to about 55 wt %, by total dry weight of the opaque layer composition.

In one example, either the filler or filler package can include a mineral powder, organohalogenated compound, a polymeric brominated compound, a metal and phosphorus containing composition, a phosphorus containing composition, a nitrogen containing composition, a halogen, an organophosphate, or combination thereof and from 10 wt % to 90 wt % of the opaque layer based on dry weight of the opaque layer.

The size of the filler particles can also vary. In one example, the filler particles can have an average particle size ranging from about 0.1 μm to about 20 μm. In another example, the filler particles can have an average particle size ranging from about 0.2 μm to about 18 μm. In yet another example, the filler particles can have an average particle size ranging from about 0.5 μm to about 10 μm. In a further example, the filler particles can have an average particle size ranging from about 1 μm to about 5 μm. In another example, the filler particles can include from 5 wt % to about 95 wt % of the opaque barrier layer based on dry weight of the opaque barrier layer and can have an average particle size from 0.1 μm to 20 μm. The filler particles can be added to the opaque barrier layer in the form of a dry powder, dispersed in a slurry, or in the form of an aqueous suspension.

Other functional additives can be added to the opaque reflective coating composition, for specific property control such as, for examples, optical brightener agent, optical brightener agent carrier, dyes for color hue, surfactant for wettability, and processing control agent such as deformer, and pH control base/acid buffer. In some examples, the opaque coating composition can include surfactant for wettability, and processing control agent such as deformer, and pH control base/acid buffer. In some other examples, the opaque layer further includes other processing aids, i.e. thickening agent, foaming agent such as ammonium stearate.

Black Light Absorption Layer (140)

The fabric print medium (100) of the present disclosure includes a fabric base substrate (110), with an image-side (101) and a back-side (102). An ink-receiving layer (120) is applied to the image-side (101) of the fabric base substrate (110). An opaque layer (130) is applied to the back-side (102) of the fabric base substrate (110). The black light absorption layer (140) is applied on the back-side (102) of the fabric base substrate (110) over the opaque layer (130). The black light absorption layer (140) can be considered as a light blocking layer since it can absorb and block light through the composite textile structure, i.e. the fabric base substrate.

The black light absorption layer (140) can be applied, over the opaque layer, at a dry coat weight ranging from about 10 gsm to about 70 gsm. In one other example, the black light absorption layer (140) can be applied at a dry coat weight ranging from about 15 gsm to about 60 gsm. In yet another example, the black light absorption layer can be applied, over the opaque layer, at a coating weight ranging from about 20 gsm to about 50 gsm.

The black light absorption layer (140) contains black pigments, polymeric binders and filler particles. In some examples, the black light absorption layer (140) contains a polymeric binder and filler particles that have a nature of flame retardancy (or flame retardancy properties) or contains fillers and, separately, a flame-retardant agent. The black light absorption layer can contain the same ingredients (i.e. polymeric binders and filler particles), as the one described for the opaque layer (130). The polymeric binders and filler particles of the black light absorption layer (140) can be similar or different from the ones that are present in the opaque layer (130).

The black light absorption layer further includes a carbon black pigment. The black pigment can be present in the black light absorption layer in an amount ranging from about 0.5% to 5% by total weight of the black light absorption layer. In some other examples, the black pigment can be present in an amount ranging from about 1 to 3% by total weight of the black light absorption layer.

Black pigment may include carbon black pigment or organic black pigment such as aniline black, e.g., C.I. Pigment Black 1. While several examples have been given herein, it is to be understood that any other pigment can be used that is useful in color modification, or dye may even be used in addition to the pigment. Carbon black may be a suitable black pigment. Examples of carbon black pigments include those manufactured by Mitsubishi chemical corporation, japan (such as, e.g., carbon black no. 2300, no. 900, mcf88, no. 33, no. 40, no. 45, no. 52, mal, ma8, ma100, and no. 2200b); various carbon black pigments of the raven® series manufactured by Columbian chemicals company, Marietta, Ga., (such as, e.g., raven® 5750, raven® 5250, Raven® 5000, Raven® 3500, Raven® 1255, and Raven® 700); various carbon black pigments of the regal® series, the mogul® series, or the monarch® series manufactured by Cabot corporation, (such as, e.g., Regal® 400r, Regal® 330r, Regal® 660r, Mogul® e, Mogul® l, and Elftex® 410); and various black pigments manufactured by Evonik Degussa Orion corporation (such as, e.g., color black fw1, color black fw2, color black fw2v, color black fw18, color black fw200, color black s150, color black s160, color black s170, Printex® 35, Printex® u, Printex® v, Printex® 140u, special black 5, special black 4a, and special black 4). An example of an organic black pigment includes aniline black, such as C.I. Pigment Black 1. Furthermore, pigments that are commercially available sometimes include both the pigment and a dispersant suitable for ink composition formulation. Specific examples of pigment dispersions that can be used, which include both pigment solids and dispersant are provided by example, as follows: HPC-K048 carbon black dispersion from DIC Corporation (Japan), HSKBPG-11-CF carbon black dispersion from Dom Pedro (USA).

Protective Layer (150)

The fabric print medium (100) of the present disclosure includes a fabric base substrate 110, with an image-side (101) and a back-side 102. An opaque layer (130) and a black light absorption layer (140) are applied to the back-side (102) of the fabric base substrate (110). The black light absorption layer (140) is applied over the opaque layer (130). A protective layer (150) is further applied on the back-side (102) of the fabric base substrate (110), over the black light absorption layer (140). The protective layer (150) comprises two or more binders. In some examples, the protective layer (150) comprises two or more latex binders, each binder having a different glass transition temperature (Tg).

In some examples, the protective layer (150) comprises a first and a second binder. The first binder would have, for examples, a glass transition temperature (Tg) which is below 0° C. and the second binder would have, for examples, a glass transition temperature (Tg) which is above 0° C. In some other examples, the protective layer (150) comprises a first and a second binder wherein the first binder would have, for examples, a glass transition temperature (Tg) which is below −10° C. and the second binder would have, for examples, a glass transition temperature (Tg) which is above 10° C. . In yet some other examples, the protective layer (150) comprises a first and a second binder wherein the first binder would have, for examples, a glass transition temperature (Tg) which is below −20° C. and the second binder would have, for examples, a glass transition temperature (Tg) which is above 20° C. The way of measuring the glass transition temperature (Tg) parameter is described in, for example, Polymer Handbook, 3rd Edition, authored by J. Brandrup, edited by E. H. Immergut, Wiley-Interscience, 1989. Examples of binders include commercial chemicals marketed under the trade name Joncryl® (from BASF), Acronal® (from BASF), FlexBond® (from Rosco) and Sancure® (from Lubrizol).

In some examples, a first binder component is a latex containing particles of a vinyl acetate-based polymer, an acrylic polymer, a styrene polymer, a styrene-butadiene rubber (SBR)-based polymer, a polyester-based polymer, a vinyl chloride-based polymer, or the like. In yet some other examples, the binder is a polymer, or a copolymer, selected from the group consisting of acrylic polymers, vinyl-acrylic copolymers and acrylic-polyurethane copolymers. Such binders can be polyvinylalcohol or copolymer of vinylpyrrolidone. The copolymer of vinylpyrrolidone can include various other copolymerized monomers, such as methyl acrylates, methyl methacrylate, ethyl acrylate, hydroxyethyl acrylate, hydroxyethyl methacrylate, ethylene, vinylacetates, vinylimidazole, vinylpyridine, vinylcaprolactams, methyl vinylether, maleic anhydride, vinylamides, vinylchloride, vinylidene chloride, dimethylaminoethyl methacrylate, acrylamide, methacrylamide, acrylonitrile, styrene, acrylic acid, sodium vinylsulfonate, vinylpropionate, and methyl vinylketone, etc. Examples of binders include, but are not limited to, polyvinyl alcohols and water-soluble copolymers thereof, e.g., copolymers of polyvinyl alcohol and poly(ethylene oxide) or copolymers of polyvinyl alcohol and polyvinylamine; cationic polyvinyl alcohols; aceto-acetylated polyvinyl alcohols; polyvinyl acetates; polyvinyl pyrrolidones including copolymers of polyvinyl pyrrolidone and polyvinyl acetate; gelatin; silyl-modified polyvinyl alcohol; styrene-butadiene copolymer; acrylic polymer latexes; ethylene-vinyl acetate copolymers; polyurethane resin; polyester resin; and combination thereof. In some examples, the binder is carboxylated styrene-butadiene copolymer binder. Such binder can be found commercially under the tradename Genflow® and Acrygen® from Omnova Solutions.

In some examples, a second binder component is a polymeric material that can include a polystyrene-butadiene emulsion, acrylonitrile butadiene latex, acrylic emulsion, vinyl acetate emulsion, vinylidene chloride emulsion, polyester emulsion, polyvinyl pyrrolidine, polyvinyl alcohol, styrene butadiene emulsions, or a combination thereof. In some other examples, the second binder component is one or more acrylic resins or acrylic resin emulsions.

Acrylic resins include, but are not limited to copolymers with other acrylic monomers, copolymers with other acrylic polymers, styrenated acrylic resins, styrenated acrylic resin solutions, Acrylic Emulsions made from Acrylic Resins and/or Acrylic Resin Solutions, Joncryl® HPD 96, Joncryl® 56, Joncryl® 57, Joncryl® 58, Joncryl® 59, Joncryl® 60, Joncryl® 61, Joncryl® 62, Joncryl® 63, Joncryl® 70, Joncryl® HPD 71, Joncryl® 73, Joncryl® ECO 75, Joncryl® ECO 84, Joncryl® DFC 3015, Joncryl® DFC 3025, Joncryl® 52, Joncryl® 50, Vancryl® 65, Vancryl® 68, Vancryl® 68S, Vancryl® 710, Joncryl® 67, Joncryl® 586, Joncryl® 611, Joncryl® HPD 671, Joncryl® ECO 675, Joncryl® 678, Joncryl® 680, Joncryl® 682, Joncryl® ECO 684, Joncryl® 690, Joncryl® 693, Joncryl® HPD 696 and combinations thereof.

Acrylic Emulsions include, but are not limited to emulsions made from the following: copolymers with other acrylic monomers, copolymers with other acrylic polymers, acrylic binders, acrylic vinyl acetate co-polymers, acrylic vinyl ethylene co-polymers, acrylic vinyl ethylene chlorides co-polymer blends, acrylics co-polymer of any wax, acrylic paraffin wax copolymer, acrylic paraffin blends, acrylic polyethylene wax co-polymer blends, acrylic co-polymer blends with polypropylene waxes, acrylic co-polymers and co-polymer blends with glycols and polyhydric alcohols, acrylic copolymer and copolymer blends of polycarbonates, acrylic copolymers and co-polymers of polyurethanes, acrylic copolymers and copolymer blends of phthalates, styrenated acrylic emulsions, Joncryl® 74, Joncryl® 77, Joncryl® 585, Joncryl® 617, Joncryl® 624, Joncryl® 660, Joncryl® 1536, Joncryl® HRC 1645, Joncryl® HRC 1620, Joncryl® HRC 1661, Joncryl® HRC 1663, Joncryl® 1695, Joncryl® ECO 2117, Joncryl® ECO 2124, Joncryl® ECO 2177, Joncryl® 2178, Joncryl® 2640, Joncryl® 2641, Joncryl® 2660, Joncryl® DFC 3030, Joncryl® DFC 3040, Joncryl® DFC 3060, Vancryl® 989, Vancryl® 937, Vancryl® 965, Vancryl® 960, Vancryl® 965, Vancryl® 960, Vancryl® 965 DEV, Vancryl® 990 EXP, Joncryl® 89, Joncryl® 537, Joncryl® 538, Joncryl® 631, Joncryl® 1680, Joncryl® 2153, Joncryl® 2161, Joncryl® ECO 2189, Joncryl® DFC 3050.

In some examples, the fabric printable medium has a protective layer (150) that comprises two latex binders with different glass transition temperature (Tg). In some other examples, the protective layer (150) comprises a first binder with glass transition temperature (Tg) of about −20° C. and a second binder with glass transition temperature (Tg) of about +20° C. In yet some other examples, the protective layer (150) comprises a first binder, which is a styrene-butadiene rubber (SBR) latex, with glass transition temperature (Tg) of about −20° C. and a second binder, which is an acrylic latex, with glass transition temperature (Tg) of about +20° C.

The ratio between the first and the second binder, in the protective layer, may vary: in some examples, the ratio first/second binder is in the range of 5/95 to 30/70. In some other examples, the ratio first/second binder is in the range of 10/90 to 20/80.

The protective layer (150) can be applied, over the black light absorption layer (140), at a dry coat weight ranging from about 0.1 gsm to about 40 gsm. In one other example, the protective layer (150) can be applied at a dry coat weight ranging from about 1 gsm to about 30 gsm. In yet another example, the protective layer (150) can be applied, over the black light absorption layer (140), at a coating weight ranging from about 5 gsm to about 25 gsm.

Method for Forming a Fabric Printable Medium

In some examples, according to the principles described herein, a method (200) for forming a fabric printable medium with a fabric base substrate (110) having, on its image side (101), an image receiving layer (120), and having, on its back-side (102), an opaque layer (130), a black light absorption layer (140) and a protective layer (150) is provided.

FIG. 2 is a flowchart illustrating a method of making the recording medium such as described herein. Such method encompasses providing (210) a fabric base substrate (110) with an image-side (101) and a back-side (102); applying (220) an ink-receiving layer (120) on the image-side (101) of the fabric base substrate (110); applying (230) an opaque layer (130) on the back-side (102) of the fabric base substrate (110); applying (240) a black light absorption layer (140) over the opaque layer (130); and applying (250) a protective layer (150) on the top of black light absorption layer (140) and obtaining (160) the printable medium (100).

The method for producing a printable medium includes weaving the supporting fabric substrate, on the loom. The method further encompasses coating an ink-receiving layer (120), onto an image side (101) of the supporting fabric base substrate (110). The ink-receiving layer (120), the opaque layer (130), the black light absorption layer (140) and the protective layer (150) can be applied by any coating method. The coating methods may include, but are not limited to blade coating processes, rod coating processes, floating knife, knife on the roll, air-knife coating processes, curtain coating processes, slot coating processes, jet coating processing or any combination thereof. The layers can be dried by any suitable means, including, but not limited to, convection, conduction, infrared radiation, atmospheric exposure, or other known method.

A calendering process can then be used to achieve the desired gloss or surface smoothness. Calendering is the process of smoothing the surface of the paper by pressing it between nips formed in a pair of rollers. The rollers can be metal hard roll, and soft roll covered with a resilient cover, such as a polymer roll. The resilient-surface roll adapts itself to the contours of the surface of the substrate and presses the opposite side of substrate evenly against the smooth-surface press roll. Any of a number of calendering devices and methods can be used. The calendering device can be a separate super-calendering machine, an on-line calendering unit, an off-line soft nip calendering machine, or the like. In some examples, the calendering is carried out at a temperature ranging from about 50 to about 150° C. (metal roll surface temperature) and, in some other examples, from about 80 to about 110° C. The nip pressure can be any value between about 100 to about 500 KN/cm2.

Printing Method

Once the coating compositions are applied to the fabric base substrate and appropriately dried, ink compositions can be applied by any processes onto the fabric printable medium. In some examples, the ink composition is applied to the fabric printable medium via inkjet printing techniques. The printing method encompasses obtaining a fabric printable medium, comprising a fabric base substrate with an image-side and a back-side; an ink-receiving layer comprising, at least, one crosslinked polymeric network, applied to the image-side of the fabric base substrate; an opaque layer comprising polymeric binder and filler particles, applied to the back-side of the fabric base substrate, a black light absorption layer comprising polymeric binders, filler particles and black pigment, applied over the opaque layer; and a protective layer comprising two or more binders applied on the top of black light absorption layer; and, then, applying an ink composition onto said fabric printable medium to form a printed image. Said printed image will have, for instance, enhanced image quality and image permanence. In some examples, when needed, the printed image can be dried using any drying device attached to a printer such as, for instance, an IR heater.

The ink composition may be deposited, established, or printed on the printable medium using any suitable printing device. In some examples, the ink composition is applied to the printable medium via inkjet printing techniques. The ink may be deposited, established, or printed on the medium via continuous inkjet printing or via drop-on-demand inkjet printing, which includes thermal inkjet printing and piezoelectric inkjet printing. Representative examples of printers used to print on the printable medium or wall covering medium, as defined herein, include, but are not limited to, HP DesignJet printers: L25500, L26500, and L65500; HP Scitex printers: LX600, LX800, LX850, and Turbojet® 8600 UV from Hewlett-Packard Company. Representative inkjet inks used by the above-listed printers include, but are not limited to, HP 791, HP 792, and HP Scitex TJ210. The printers may be used in a standard wall paper profile with a production print mode or a normal print mode. The print mode may vary the ink application within a range of from about 50% to about 250% of each other.

Some examples of inkjet inks that may be deposited, established, or otherwise printed on the printable medium of the present disclosure include pigment-based inkjet inks, pigmented latex-based inkjet inks, and UV curable inkjet inks. In some examples, the ink composition is an inkjet ink composition that contains one or more colorants that impart the desired color to the printed message and a liquid vehicle. As used herein, “colorant” includes dyes, pigments, and/or other particulates that may be suspended or dissolved in an ink vehicle. The colorant can be present in the ink composition in an amount required to produce the desired contrast and readability. In some examples, the ink compositions include pigments as colorants. Pigments that can be used include self-dispersed pigments and non-self-dispersed pigments. Any pigment can be used; suitable pigments include black pigments, white pigments, cyan pigments, magenta pigments, yellow pigments, or the like. Pigments can be organic or inorganic particles as well known in the art. As used herein, “liquid vehicle” is defined to include any liquid composition that is used to carry colorants, including pigments, to a substrate. A wide variety of liquid vehicle components may be used and include, as examples, water or any kind of solvents.

In some other examples, the ink composition, applied to the fabric print medium, is an ink composition containing latex components. Latex components are, for examples, polymeric latex particulates. The ink composition may contain polymeric latex particulates in an amount representing from about 0.5 wt % to about 15 wt % based on the total weight of the ink composition. The polymeric latex refers herein to a stable dispersion of polymeric micro-particles dispersed in the aqueous vehicle of the ink. The polymeric latex can be natural latex or synthetic latex. Synthetic latexes are usually produced by emulsion polymerization using a variety of initiators, surfactants and monomers. In various examples, the polymeric latex can be cationic, anionic, nonionic, or amphoteric polymeric latex. Monomers that are often used to make synthetic latexes include ethyl acrylate; ethyl methacrylate; benzyl acrylate; benzyl methacrylate; propyl acrylate; methyl methacrylate, propyl methacrylate; iso-propyl acrylate; iso-propyl methacrylate; butyl acrylate; butyl methacrylate; hexyl acrylate; hexyl methacrylate; octadecyl methacrylate; octadecyl acrylate; lauryl methacrylate; lauryl acrylate; hydroxyethyl acrylate; hydroxyethyl methacrylate; hydroxyhexyl acrylate; hydroxyhexyl methacrylate; hydroxyoctadecyl acrylate; hydroxyoctadecyl methacrylate; hydroxylauryl methacrylate; hydroxylauryl acrylate; phenethyl acrylate; phenethyl methacrylate; 6-phenylhexyl acrylate; 6-phenylhexyl methacrylate; phenyllauryl acrylate; phenyllauryl methacrylate; 3-nitrophenyl-6-hexyl methacrylate; 3-nitrophenyl-18-octadecyl acrylate; ethyleneglycol dicyclopentyl ether acrylate; vinyl ethyl ketone; vinyl propyl ketone; vinyl hexyl ketone; vinyl octyl ketone; vinyl butyl ketone; cyclohexyl acrylate; methoxysilane; acryloxy-propyhiethyl-dimethoxysilane; trifluoromethyl styrene; trifluoromethyl acrylate; trifluoromethyl methacrylate; tetrafluoropropyl acrylate; tetrafluoropropyl methacrylate; heptafluorobutyl methacrylate; butyl acrylate; iso-butyl methacrylate; 2-ethylhexyl acrylate; 2-ethylhexyl methacrylate; isooctyl acrylate; and iso-octyl methacrylate. In some examples, the latexes are prepared by latex emulsion polymerization and have an average molecular weight ranging from about 10,000 Mw to about 5,000,000 Mw. The polymeric latex can be selected from the group consisting of acrylic polymers or copolymers, vinyl acetate polymers or copolymers, polyester polymers or copolymers, vinylidene chloride polymers or copolymers, butadiene polymers or copolymers, polystyrene polymers or copolymers, styrene-butadiene polymers or copolymers and acrylonitrile-butadiene polymers or copolymers. The latex components are on the form of a polymeric latex liquid suspension. Such polymeric latex liquid suspension can contain a liquid (such as water and/or other liquids) and polymeric latex particulates having a size ranging from about 20 nm to about 500 nm or ranging from about 100 nm to about 300 nm.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise. In describing and claiming the examples disclosed herein, the singular forms “a”, “an”, and “the” include plural referents unless the context clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “acid value” or “acid number” refers to the mass of potassium hydroxide (KOH) in milligrams that can be used to neutralize one gram of substance (mg KOH/g), such as the latex polymers disclosed herein. This value can be determined, in one example, by dissolving or dispersing a known quantity of a material in organic solvent and then titrating with a solution of potassium hydroxide (KOH) of known concentration for measurement.

The term “(meth)acrylate,” “(meth)acrylic,” or “(meth)acrylic acid,” or the like refers to monomers, copolymerized monomers, etc., that can either be acrylate or methacrylate (or a combination of both), or acrylic acid or methacrylic acid (or a combination of both). This can be the case for either dispersant polymer for a pigment dispersion or for dispersed polymer binder particles that may include co-polymerized acrylate and/or methacrylate monomers. Also, in some examples, the terms “(meth)acrylate” and “(meth)acrylic” can be used interchangeably, as acrylates and methacrylates described herein include salts of acrylic acid and methacrylic acid, respectively. Thus, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt form). Thus, a monomer or a moiety of a polymer described as (meth)acrylic acid or as (meth)acrylate should not be read so rigidly as to not consider relative pH levels, and other general organic chemistry concepts.

As used herein, “liquid vehicle” or “ink vehicle” refers to a liquid fluid in which colorant, such as pigments, can be dispersed and otherwise placed to form an ink composition. A wide variety of liquid vehicles may be used with the systems and methods of the present disclosure. Such liquid vehicles may include a mixture of a variety of different agents, including, water, organic co-solvents, surfactants, anti-kogation agents, buffers, biocides, sequestering agents, viscosity modifiers, surface-active agents, water, etc.

As used herein, “pigment” generally includes pigment colorants.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc. In some other examples, a range of 1 part to 20 parts should be interpreted to include not only the explicitly recited concentration limits of about 1 part to about 20 parts, but also to include individual concentrations such as 2 parts, 3 parts, 4 parts, etc. All parts are dry parts in unit weight, with the sum of all the coating components equal to 100 parts, unless otherwise indicated.

To further illustrate the present disclosure, examples are given herein. It is to be understood that these examples are provided for illustrative purposes and are not to be construed as limiting the scope of the present disclosure.

### EXAMPLES

The raw materials and chemical components used in the illustrating samples are listed in Table 1.

TABLE 1

| Ingredients | Nature of the ingredients | Supplier |
|---|---|---|
| Sancure ® 2026 | Polyurethane polymer | Lubrizol Inc. |
| Sancure ® AU4010 | Self-Crosslinking aliphatic | Lubrizol Inc. |
| | polyurethane-acrylic network | |
| Genflow ® 3000 | carboxylated styrene-butadiene | Omnova Solutions |
| | copolymer binder | |
| Aerosol ® OT-75 | dispersants | Dow chemical |
| Tegowet ® 510 | Surfactant | Evonik Industries |
| Antimony trioxide | FR/synergist | Prochem Inc |
| Sterocoll ® FS | Rheology control gent | BASF |
| Tylose ® HS 100000 | Rheology control gent | Tylose GmbH & Co |
| Araldite ® PZ 3901 | epoxy functional resins | Huntsman International LLC |
| Aradur ® 3985 | epoxy resin hardeners | Huntsman International LLC |
| Firemaster ® 2100R | flame-retardant agents | Chemtura Group |
| Joncryl ® 2640 | Acrylic Copolymers emulsions | BASF |
| Alcosperese ® 149 | Dispersing agent/surfactant | AkzoNobel |
| Acronal ® S 589 | Binder | BASF |
| Sancure ® 850 | Binder | Lubrizol |
| Ammonium stearate emulsion | Foam stabilizer | UPI |
| Dynwet ® 800 | Surfactant | BYK Inc |
| Ammonium hydroxide solution | pH control | Aldrich |
| Sterocoll ® FS | Thickener | BASF |
| Genflow 3000 | Binder | Omnova Solutions |
| Aersol ® OT-75 (AOT-75) | Dispersant | Dow chemical |
| Carbon Black | Colorant | Columbian Chemicals Company |

### Example 1—Preparation of Printable Medium Samples

Different media were made using different fabric base substrates and different coating compositions. Two woven fabrics (FA and FB) were used in the experiment. Fabric A (FA) is a 100% woven polyester fabric having a weight of 70 gsm with 1×1 weaves. Fabric B (FB) is a 140 gsm 100% woven polyester fabric with 2×2 simple plan weave. Before the coating step, each of the fabric A and B are first prepared with various steps including scouring, heat setting, and whitening etc.

The formulations of the ink-receiving layer (120), the opaque layer (130), the black light absorption layer (140), and the protective layer (150) are illustrated, respectively, in the Tables 2, 3, 4 and 5 below. Each number represents the wt % of each ingredient in dry wt % per total weight of the ingredients.

TABLE 2
Ink-receiving layer (120)

| Chemical Components | IR1 | IR2 |
|---|---|---|
| Tylose ® HS100000 | 3.6% | 2.1% |
| Sterocoll ® FS. | 3.6% | 2.1% |
| Sancure ® AU4010 | 35.6% | 20.8% |
| Araldite ® PZ 3901 | 7.2% | 25% |
| Aradur ® 3985 | 7.2% | 25% |
| Sancure ® 2026 | 42.8% | 25% |

TABLE 3
Opaque Layer (130)

| Chemical Components | OP |
|---|---|
| Acronal ® S 589 | 18.5% |
| Sancure ® 2026 | 4.6% |
| Aersol ® OT-75 | 1.6% |
| Alcosperese ® 149 | 0.5% |
| Antimony trioxide | 13.7% |
| Firemaster ® 2100R | 27.5% |
| Tegowet ® 510 | 1.5% |
| Genflow ® 3000 | 23.0% |
| Ammonium stearate emulsion | 8.1% |
| Sterocoll ® FS. | 1.0% |

TABLE 4
Black light absorption layer (140)

| Chemical Components | BL |
|---|---|
| Acronal ® S 589 | 23.2% |
| Aersol ® OT-75 | 1.6% |
| Antimony trioxide | 13.8% |
| Firemaster ® 2100R | 27.6% |
| Tegowet ® 510 | 1.5% |
| Genflow ® 3000 | 23.2% |
| Ammonium stearate emulsion | 6.6% |
| Carbon Black | 1.5% |
| Sterocoll ® FS | 1.0% |

TABLE 5
Protective layer (150)

| Chemical Component | PT |
|---|---|
| Genflow ® 3000 | 9.9% |
| Joncryl ® 2640 | 89.4% |
| Sterocoll ® FS | 0.7% |

Different media (samples 1 to 4) are made using the different coating formulations. Each layer is coated at a different coat weigh onto the fabric base substrate. The media sample structures are illustrated in Table 6. A commercial fabric coater with padding, knife coating stations, 8 drying ovens and in line-calender was used. The pre-treated fabrics (A and B) are dip coated with ink fixing coating at 3% solids by a padding machine per formulation IR1 and IR2 respectively.

TABLE 6

| | | | | Black Light | |
|---|---|---|---|---|---|
| | base substrate | Ink fixing | Opaque Layer | Reflective Layer | Protective Layer |
| Media | (110) | layer (120) | (130) | (140) | (150) |
| Sample 1 | Fabric A | IR1 − 10 gsm | OP − 40 gsm | BL − 25 gsm | PT − 15 gsm |
| Sample 2 | Fabric A | IR 2 − 10 gsm | OP − 40 gsm | BL − 25 gsm | PT − 15 gsm |
| Sample 3 | Fabric B | IR 1 − 10 gsm | OP − 40 gsm | BL − 25 gsm | PT − 15 gsm |
| Sample 4 | Fabric B | IR 2 − 10 gsm | OP − 40 gsm | BL − 25 gsm | PT − 15 gsm |

### Example 2—Samples Performances

The same images are printed on the media samples 1, 2, 3 and 4 using an HP Latex 360 printer. The resulting printed fabric mediums are evaluated for different performances: Scratch resistances, ink abrasions, Folding Resistance and Opacity. The results of these tests are expressed in the Table 7 below.

Image quality is evaluated using both numeric measurement method and visual evaluation method. Coin scratch performance is measured using a taber abrasion unit per ISO 1518:2011 method, and ink rub is measured using a taber unit per ASTM F2497-05(2011) e1. Fabric soft hand is tested to see if fabric after coating is maintaining the softness of raw fabric. Wrinkle resistance is tested by wrinkling the fabric and evaluating the ability of wrinkle recovery over 24 hours. Both fabric softness and wrinkle are evaluated visually and rated with a score ranging from 1 to 5. (5 being the best, 1 being the worse result). The opacity was tested using TAPPI test method T425 (The opacity is expressed in percentage %).

TABLE 7

| | | Taber Ink | Fabric Hand | Folding | |
|---|---|---|---|---|---|
| | Coin Scratch | abrasion | softness | Resistance | Tappi |
| Sample | 5 = no damage | 5 = no ink transfer | 1 = most rigid | 5 = No ink damage | Opacity |
| sample 1 | 4.5 | 4 | 3 | 4 | 99.5% |
| sample 2 | 4.5 | 4 | 4 | 4 | 99.5% |
| sample 3 | 5 | 4 | 2 | 4 | 100% |
| sample 4 | 4.5 | 4 | 3 | 4 | 100% |

1) A fabric printable medium comprising:
a. a fabric base substrate with an image-side and a back-side;
b. an ink-receiving layer comprising, at least, one crosslinked polymeric network, applied to the image-side of the fabric base substrate;
c. an opaque layer comprising polymeric binders and filler particles, applied to the back-side of the fabric base substrate;
d. a black light absorption layer comprising polymeric binders, filler particles and black pigments, applied over the opaque layer;
e. a protective layer comprising two or more binders applied on the top of black light absorption layer.

2) The fabric printable medium of claim 1 wherein, in the ink-receiving layer, the crosslinked polymeric network includes polyacrylate based polymers

3) The fabric printable medium of claim 1 wherein the ink-receiving layer includes an epoxy functional resin in an amount representing above 5% of the total amount of ingredients of the ink-receiving layer.

4) The fabric printable medium of claim 1 wherein the ink-receiving layer further includes a rheology control agent.

5) The fabric printable medium of claim 1 wherein the ink-receiving layer has a coat-weigh ranging from about 0.1 gsm to about 40 gsm.

6) The fabric printable medium of claim 1 wherein the opaque layer is applied on the back-side of the fabric base substrate at a dry coat-weight ranging from about 10 gsm to about 80 gsm.

7) The fabric printable medium of claim 1 wherein in the opaque layer, the fillers are particles with flame retardancy properties.

8) The fabric printable medium of claim 1 wherein the opaque layer comprises inorganic particle fillers that are titanium dioxide (TiO₂) particles.

9) The fabric printable medium of claim 1 wherein, in the black light absorption layer, the black pigment is present in an amount ranging from about 0.5 wt % to 5 wt % by total weight of the black light absorption layer.

10) The fabric printable medium of claim 1 wherein the protective layer comprises two or more latex binders, each binder having a different glass transition temperature (Tg).

11) The fabric printable medium of claim 10 wherein the protective layer comprises a first and a second binder with a ratio first/second binder in the range of about 5/95 to about 30/70.

12) A method for forming a fabric printable medium comprising:
a. providing a fabric base substrate, with an image-side and a back-side;
b. applying an ink-receiving layer comprising, at least, one crosslinked polymeric network, on the image-side of the fabric base substrate;
c. applying an opaque layer, comprising polymeric binder and filler particles, on the back-side of the fabric base substrate;
d. applying a black light absorption layer, comprising polymeric binders, filler particles and black pigment, over the opaque layer;
e. and applying a protective layer, comprising two or more binders, on the top of black light absorption layer.

13) A printing method comprising:
a. obtaining a fabric printable medium comprising a fabric base substrate with an image-side and a back-side; an ink-receiving layer comprising, at least, one crosslinked polymeric network, applied to the image-side of the fabric base substrate; an opaque layer comprising polymeric binder and filler particles, applied to the back-side of the fabric base substrate, a black light absorption layer comprising polymeric binders, filler particles and black pigment, applied over the opaque layer; and a protective layer comprising two or more binders applied on the top of black light absorption layer;
b. and applying an ink composition onto said fabric printable medium to form a printed image.

14) The printing method of claim 13 wherein the ink composition is applied to the fabric printable medium via inkjet printing techniques.

15) The printing method of claim 13 wherein the ink composition is an ink composition containing latex components.
